(19) United States
(12) Patent Application Publication
(10) Pub. No.: US 2003/0141733 A1
(43) Pub. Date: Jul. 31, 2003

(54) Vehicle with extendable cargo bed

(76) Inventor: Donald E. Burg, Miami, FL (US)

Correspondence Address: Donald E. Burg, 15840 S.W. 84 Avenue, Miami, FL, 33157, US

(21) Appl. No.: 10/062,130

(22) Filed: Jan. 31, 2002

(51) Int. Cl. B62D 33/02

(52) U.S. Cl. 296/26.09

(57) ABSTRACT

An extendable cargo bed system for land vehicles that allows operation with the cargo bed stored and out of the way during normal day to day operation of the vehicle is presented. It has particular application to pickup trucks and sport utility vehicles. The extendable cargo bed system is easily deployed by hand or actuators and includes night and brake lighting members so that it passes government highway regulations. A rear window that swings out of the way which is particularly valuable for sport utility vehicles is also offered.

### BACKGROUND OF THE INVENTION

There is a need for longer cargo beds on sport utility vehicles, commonly know as SUVs, and many pickup trucks. Both of these vehicle types are being offered with large passenger areas forward. This results in a necessary shortening of the cargo bed area aft to keep the overall length of the vehicle within reason. This is so that they can be relatively easily maneuvered into and out of restricted size parking spaces and garages.

A particular example is brought about by the rise in popularity of four door pickup trucks. After allowing for the passenger area forward, the length of the pickup truck cargo bed is only five feet for full size and even less for compact pickup trucks. This contrasts with the need to transport up to eight feet of cargo in many instances.

The instant invention addresses the difficulties brought about by the shorting of the cargo beds of these vehicles by offering an easily deployable extension to their cargo beds. The cargo bed extension offered can be either automatically extended by use of a powered actuator or by hand.

### SUMMARY OF THE INVENTION

It is a principal object of the instant invention to provide an improved vehicle with a first cargo bed member and a second cargo bed member wherein said second cargo bed member is extendable aft beyond the first cargo bed member to thereby create a longer cargo bed for the improved vehicle.

It is a related object of the invention that the second cargo bed member may slide aft from under the first cargo bed member during rearward extension of the second cargo bed member.

It is another related object of the invention that the second cargo bed member extends aft in a substantially linear manner.

It is another object of the invention that a lighting member may be disposed, at least in part, on the second cargo bed member and that said lighting member is deployed rearward with the second cargo bed member when the second cargo bed member is extended to its aft position.

It is yet another object of the invention that the second cargo bed member is at least partially supported by an extendable slide mount.

It is a directly related object of the invention that extendable slide mount be comprised of two or more sliding elements.

It is another related object of the invention that at least two of the sliding elements be separated by ball bearings.

Yet a further related object of the invention is that one of the slide elements may be mechanically fixed in position relative to the first cargo bed member.

Another object of the invention is that a supporting device be in mechanical communication with both the first cargo bed member and the second cargo bed member where said supporting member adds support to the first cargo bed member.

It is a directly related object of the invention that the supporting device be, at least in part, a rolling element.

Another object of the invention is that, on average and when the vehicle is on a horizontal surface, the cargo supporting bed surface of the first cargo bed member is higher than the cargo supporting bed surface of the second cargo bed member.

It is still another object of the invention that a cargo tailgate member be in mechanical communication with the second cargo bed member and move forward and aft with the second cargo bed member.

Yet another object of the invention is that a main bumper member be in mechanical communication with the second cargo bed member and move forward and aft with the second cargo bed member.

A directly related object of the invention is that a supporting bumper member be proximal to the main bumper member when the second cargo bed is retracted.

Another object of the invention is that an actuator system be provided to supply the forces for movement of the second cargo bed member.

A directly related object of the invention is that the actuator system include a motor that drives a pinion gear that in turn drives a rack gear that is in mechanical communication with the second cargo bed member.

Yet still another object of the invention is that a rear window of the vehicle may swing upward and forward over a portion of a passenger compartment of the vehicle.

Another object of the invention is that a rear window of the vehicle may swing downward and forward into an internal roof portion of a passenger compartment.

Still another object of the invention is that when the second cargo bed is extended aft that it enlarges the overall cargo bed length by at least 40 percent.

A further object of the invention is that by extending the second cargo bed aft the overall cargo bed length is enlarged by at least 65 percent.

Still another object of the invention is that by extending the second cargo bed aft the overall cargo bed length is enlarged by at least 90 percent.

A further object of the invention is that the inventive vehicle is a pickup truck.

Yet another object of the invention is that the inventive vehicle is a SUV.

Another object of the invention is that the second cargo bed member have a tailgate disposed proximal its aft end.

A further object of the invention is that the improved vehicle be a SUV having a cargo bed member wherein said cargo bed member is extendable aft beyond the passenger compartment of the SUV to thereby create an exposed cargo bed for the SUV and said cargo bed member having a tailgate disposed proximal its aft end.

### BRIEF DESCRIPTION OF THE DRAWINGS

FIG. 1 presents a perspective view of an instant invention pickup truck with the extendable cargo bed retracted.

FIG. 2 is the same perspective view as given in FIG. 1 but with the instant invention extendable cargo bed in its rearmost position.

FIG. 3 is a similar perspective view of a vehicle to the instant invention as given in FIG. 2 but in this case it is a SUV. Note that the tailgate is shown lowered in this figure.

FIG. 4 presents a partial cutaway view of a rear part of the passenger compartment of the SUV shown in FIG. 3. In this instance, the rear window is rotated upward to move it out of the way when cargo is to be carried and/or when more air movement is desired.

FIG. 5 is a similar partial cutaway view to that presented in FIG. 4, however, in this case the rear window is rotated inward and upward to move it out of the way.

FIG. 6 presents a transverse cross section, as taken through line 6-6 of FIG. 9, of the pickup truck cargo beds. Shown are rollers that help support the stationary first cargo bed and sliding elements that support the second, moveable in relation to the pickup truck, cargo bed. Also shown is an actuator motor that provides force for inward and outward extension of the second cargo bed.

FIG. 7 is an enlarged section of a portion of FIG. 6 that shows in more detail a first cargo bed support roller, second cargo bed support side elements, and pinion and rack gears and their drive actuator motor.

FIG. 8 shows a portion of a cross section, as taken through line 8-8 of FIG. 6, that shows a pinion gear and the rack gear that it drives. The rack gear is attached to the second cargo bed so it travels in and out with the second cargo bed.

FIG. 9 presents a cross section, as taken through line 9-9 of FIG. 6, that shows the second cargo bed in its retracted position The tailgate is shown in its closed up position with a dashed outline of the tailgate illustrating its down position also given. Elements of the preferred embodiment slide members that support the second cargo bed are also shown. Note that FIGS. 9 and 10 show the cargo beds only and none of the passenger compartments of the inventive improved motorized land vehicle.

FIG. 10 gives a cross section, as taken through line 10-10 of FIG. 6, that presents the second cargo bed in its extended position which provides maximum cargo bed length.

### DETAILED DESCRIPTION

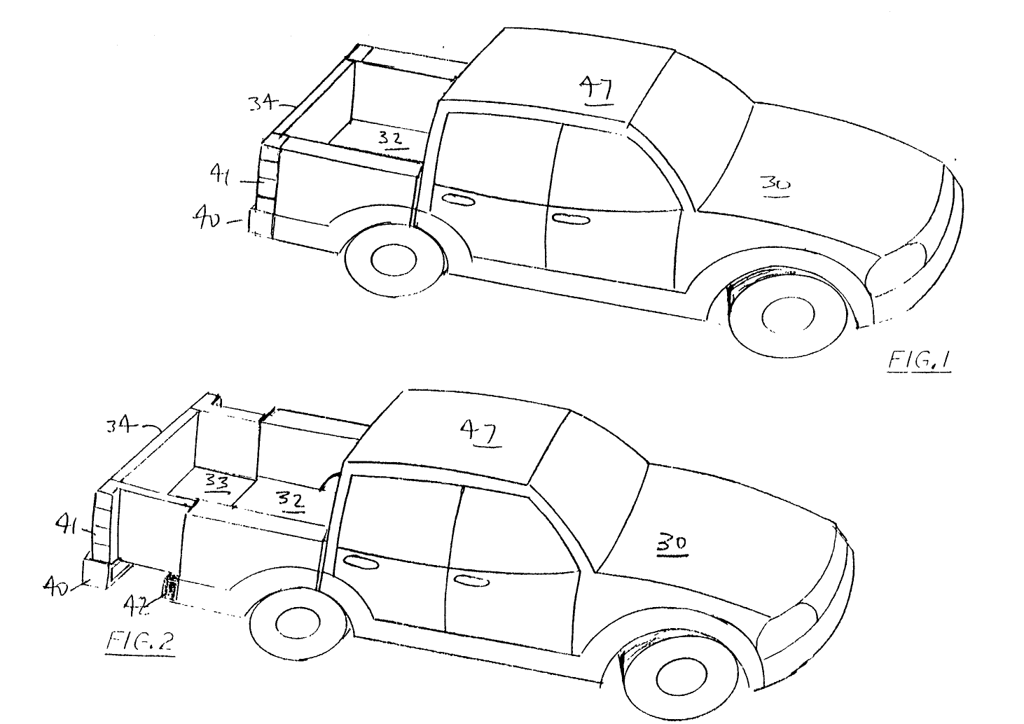

FIG. 1 shows the inventive improved motorized land vehicle 47 which in this illustration is a pickup truck 30. Shown are a first cargo bed 32, tailgate 34, lights 41, and bumper 40. The appearance here is, of course, the same as a standard commercially available pickup. In this case it has an extremely long passenger cabin due to the four-door configuration.

FIG. 2 presents the same view as that presented in FIG. 1 but with the second cargo bed 33 extended. An additional item to note here is the resilient bumper backup member 42 that engages the bumper 40 when the second cargo bed 33 is retracted. Further, it is defined here that the overall length of the cargo bed can be extended by at least 40 percent, with at least 65 percent, and even at least 90 percent extensions in length possible. It is also to be noted that while a fixed position first cargo bed and a moveable in relation to the vehicle second cargo bed are shown that more than two cargo beds may be utilized. Further, the first cargo bed can have at least some movement in relation to the vehicle if that facilitates the manufacturing and/or use of the invention.

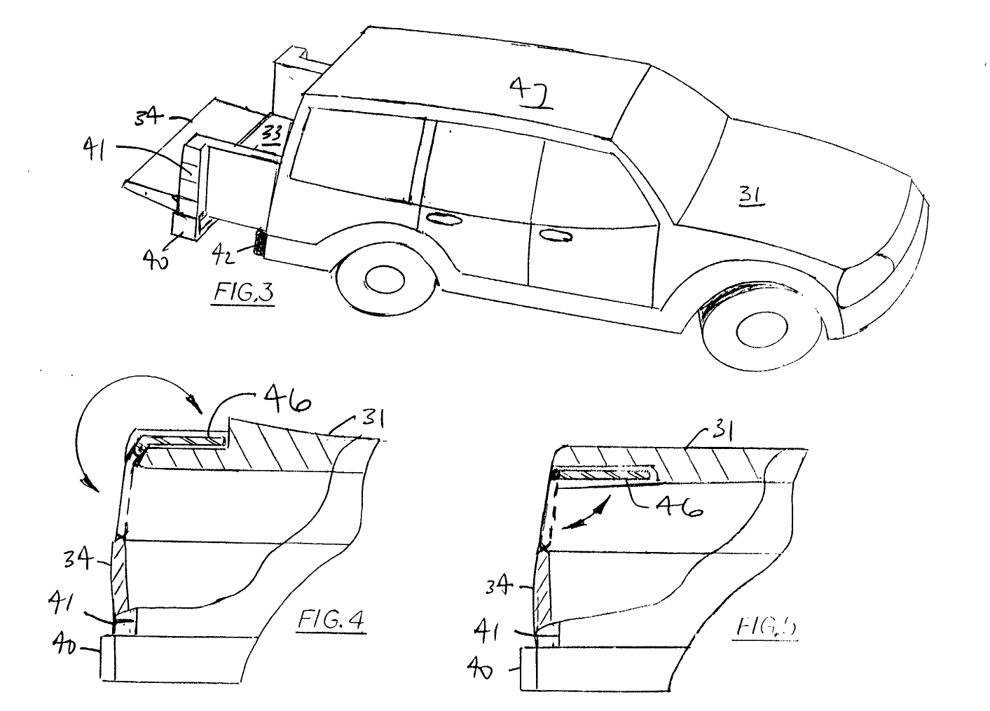

FIG. 3 is a similar perspective view of a motorized land vehicle 47 as presented in FIG. 2 but in this case it is a SUV 31. Note that the second cargo bed 33 is also extended here but that the tailgate 34 is shown in its down position for illustration purposes. It is important to note that what is noted as the second cargo bed member 33 on the SUV may be the only exposed or open cargo bed member on a SUV. In such instance the second cargo bed member 33 may be referred to simply as an extendable cargo bed member.

FIG. 4 presents a partial cutaway view of a rear part of the passenger compartment of the SUV 31 shown in FIG. 3. In this illustration, the rear window 46 is rotated upward to move it out of the way when cargo is being carried and/or when fresh air circulation is desired. In the preferred embodiment the rear window stores in a recess in the top of the external roof portion of the passenger compartment.

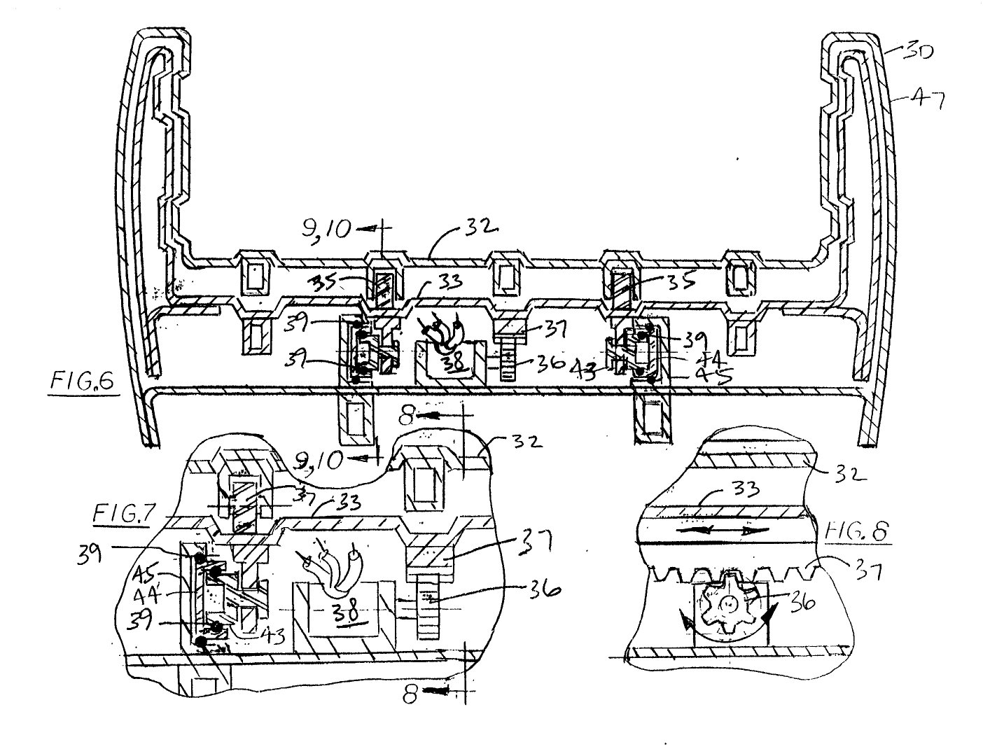

FIG. 5 is another concept for moving the rear window 46 out of the way. In this case, it is rotated inward rather than outward as was illustrated in FIG. 4. In the preferred embodiment the rear window stores into a recess set into the interior roof of the passenger compartment.

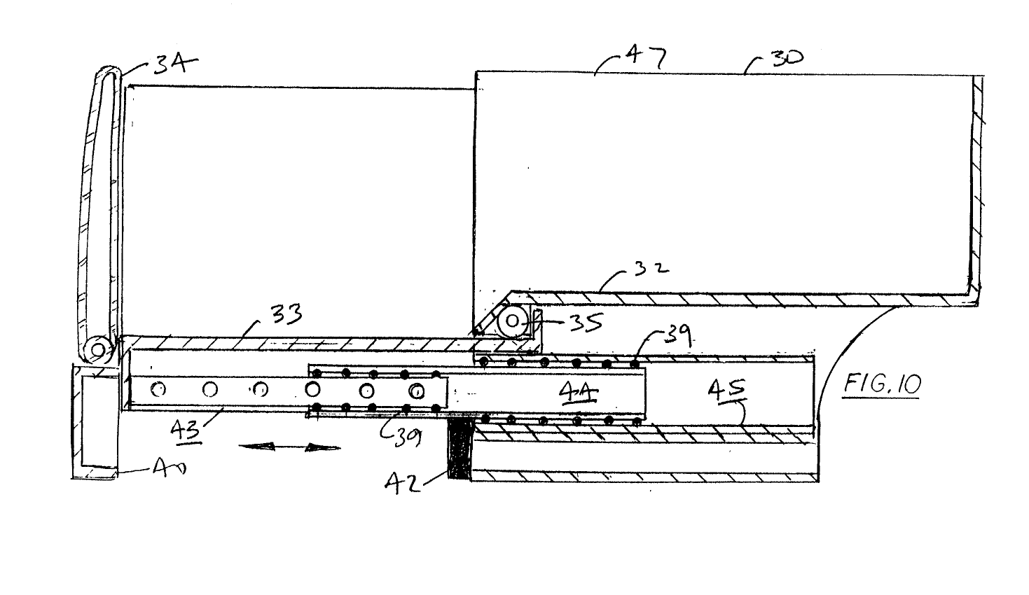

FIG. 6 presents a transverse cross section, as taken through line 6-6 of FIG. 9, of the pickup truck 31 cargo beds 32, 33 when the second cargo bed 33 is retracted. Note that the same elements apply to the SUV 31 when its second cargo bed is retracted except that the SUV would have a roof and side windows (not shown to simplify the drawings). Note also that the second cargo bed member may be the only cargo bed member in the case of the SUV as the forward compartment may be all passenger seating.

Shown in FIG. 6 are rollers 35 that help support the preferably stationary first cargo bed 32. Drive elements consisting of a pinion gear 36, rack gear 37, and actuator motor 38 for moving the second cargo bed forward and aft are also shown. Note that the drive elements, though desirable, are not required and that the second cargo bed 33 is designed to be easily moveable inward and outward by hand. Also shown are the preferred embodiment sliding elements 43, 44, and 45 that facilitate movement of the second cargo bed 33. Friction is reduced when the ball bearings 39 are employed to separate the slide elements.

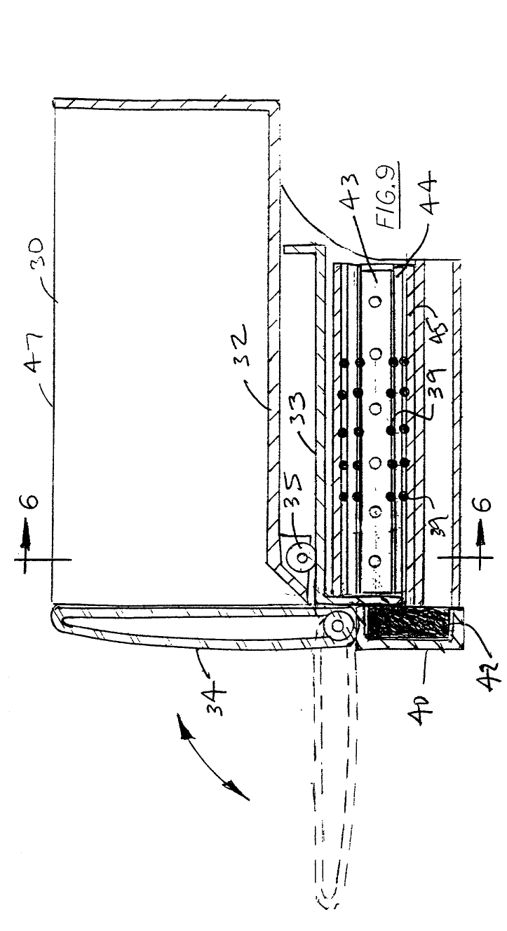

FIG. 7 presents an enlarged section of a portion of FIG. 6 that shows in more detail a first cargo bed support roller 37, rack gear 37, pinion gear 36, drive actuator motor 38, and inner slide element 43, middle slide element 44, and outer slide element 45. Note that the outer slide element 45 is normally in fixed in position relative to the first cargo bed 32 and that the inner slide element 43 is normally secured to the second cargo bed 33. It is to be noted that other means for relating the fixed first and moveable second cargo beds are also within the scope and intention of the instant invention.

FIG. 8 is a partial cross section, as taken through line 8-8 of FIG. 7, that shows a side view of the pinion gear 36 and the rack gear 37 and how there movement results in movement of the second cargo bed 33. While the rack and pinion gear concept shown in FIG. 8 is the preferred embodiment, other means of actuation including hydraulic cylinders, powered levers, or other not shown means can be easily adapted to provide the power for movement of the second cargo bed. It is also possible to move the second cargo bed in out with simple hand force due to the low force requirements offered by the preferred embodiment sliding elements that support the second cargo bed.

FIG. 9 presents a partial cross section of the cargo beds 32, 33 only, as taken through line 9-9 of FIG. 6, that shows the second cargo bed 33 in its retracted position. The tailgate 34 is in its up position with a dotted outline shown to illustrate its closed position. The inner slide element 43, middle slide element 44, and outer slide element 45 are in their positions that occur when the second cargo bed 33 in retracted. Note the resiliently biased bumper backup member 42 that is in contact with the bumper 40 here.

FIG. 10 presents a partial cross section of the cargo beds 32, 33 only, as taken through line 9-9 of FIG. 6, that shows the second cargo bed 33 in its extended position.

While the invention has been described in connection with a preferred and several alternative embodiments, it will be understood that there is no intention to thereby limit the invention. On the contrary, there is intended to be covered all alternatives, modifications, and equivalents as may be included within the spirit and scope of the invention as defined by the appended claims, which are the sole definition of the invention.

What I claim is:

1. In an improved vehicle with a first cargo bed member, the improvement comprising:
a second cargo bed member wherein said second cargo bed member is extendable aft beyond the first cargo bed member to thereby create a longer cargo bed for the improved vehicle and wherein said second cargo bed member extends aft in a substantially linear manner.

2. The improved vehicle of claim 1 wherein a lighting member is disposed, at least in part, on the second cargo bed member and is deployed rearward with the second cargo bed member when the second cargo bed member is extended to its aft position.

3. The improved vehicle of claim 1 wherein the second cargo bed member slides aft from under the first cargo bed member during rearward extension of the second cargo bed member.

4. The improved vehicle of claim 3 wherein the second cargo bed member is at least partially supported by an extendable slide mount.

5. The improved vehicle of claim 4 wherein said extendable slide mount is comprised of two or more sliding elements.

6. The improved vehicle of claim 5 wherein at least two of the sliding elements are separated by ball bearings.

7. The improved vehicle of claim 4 wherein one of the slide elements is mechanically fixed in position relative to the first cargo bed member.

8. The improved vehicle of claim 1 which further comprises a supporting device that is in mechanical communication with both the first cargo bed member and the second cargo bed member and adds support to the first cargo bed member.

9. The improved vehicle of claim 8 wherein the supporting device is, at least in part, a rolling element.

10. The improved vehicle of claim 1 wherein, on average and when the vehicle is on a horizontal surface, the cargo supporting bed surface of the first cargo bed member is higher than the cargo supporting bed surface of the second cargo bed member.

11. The improved vehicle of claim 1 wherein a cargo tailgate member is in mechanical communication with the second cargo bed member and moves forward and aft with the second cargo bed member.

12. The improved vehicle of claim 1 wherein a main bumper member is in mechanical communication with the second cargo bed member and moves forward and aft with the second cargo bed member.

13. The improved vehicle of claim 12 wherein a supporting bumper member is proximal to the main bumper member when the second cargo bed is retracted.

14. The improved vehicle of claim 1 which further comprises an actuator system to provide the forces for movement of the second cargo bed member.

15. The improved vehicle of claim 14 wherein the actuator system includes a motor that drives a pinion gear that in turn drives a rack gear that is in mechanical communication with the second cargo bed member.

16. The improved vehicle of claim 1 wherein a rear window of the vehicle swings upward and forward over a portion of a passenger compartment of the vehicle.

17. The improved vehicle of claim 1 wherein a rear window of the vehicle swings downward and forward into an internal roof portion of a passenger compartment of the vehicle.

18. The improved vehicle of claim 1 wherein extending the second cargo bed aft enlarges the overall cargo bed length by at least 40 percent.

19. The improved vehicle of claim 1 wherein extending the second cargo bed aft enlarges the overall cargo bed length by at least 65 percent.

20. The improved vehicle of claim 1 wherein extending the second cargo bed aft enlarges the overall cargo bed length by at least 90 percent.

21. The improved vehicle of claim 1 wherein said vehicle is a pickup truck.

22. The improved vehicle of claim 1 wherein said vehicle is a SUV.

23. In an improved vehicle with a first cargo bed member, the improvement comprising:
a second cargo bed member wherein said second cargo bed member is extendable aft beyond the first cargo bed member to thereby create a longer cargo bed for the improved vehicle and wherein the second cargo bed member slides aft from under the first cargo bed member during rearward extension of the second cargo bed member.

24. The improved vehicle of claim 23 wherein said second cargo bed member extends aft in a substantially linear manner.

25. The improved vehicle of claim 23 wherein a lighting member is disposed, at least in part, on the second cargo bed member and is deployed rearward with the second cargo bed member when the second cargo bed member is extended to its aft position.

26. The improved vehicle of claim 23 wherein the second cargo bed member is at least partially supported by an extendable slide mount.

27. The improved vehicle of claim 26 wherein said extendable slide mount is comprised of two or more sliding elements.

28. The improved vehicle of claim 27 wherein at least two of the sliding elements are separated by ball bearings.

29. The improved vehicle of claim 27 wherein one of the slide elements is mechanically fixed in position relative to the first cargo bed member.

30. The improved vehicle of claim 23 which further comprises a supporting device that is in mechanical communication with both the first cargo bed member and the second cargo bed member and adds support to the first cargo bed member.

31. The improved vehicle of claim 30 wherein the supporting device is, at least in part, a rolling element.

32. The improved vehicle of claim 23 wherein, on average and when the vehicle is on a horizontal surface, the cargo supporting bed surface of the first cargo bed member is higher than the cargo supporting bed surface of the second cargo bed member.

33. The improved vehicle of claim 23 wherein a cargo tailgate member is in mechanical communication with the second cargo bed member and moves forward and aft with the second cargo bed member.

34. The improved vehicle of claim 23 wherein a main bumper member is in mechanical communication with the second cargo bed member and moves forward and aft with the second cargo bed member.

35. The improved vehicle of claim 34 wherein a supporting bumper member is proximal to the main bumper member when the second cargo bed is retracted.

36. The improved vehicle of claim 23 which further comprises an actuator system to provide the forces for movement of the second cargo bed member.

37. The improved vehicle of claim 36 wherein the actuator system includes a motor that drives a pinion gear that in turn drives a rack gear that is in mechanical communication with the second cargo bed member.

38. The improved vehicle of claim 23 wherein a rear window of the vehicle swings upward and forward over a portion of a passenger compartment of the vehicle.

39. The improved vehicle of claim 23 wherein a rear window of the vehicle swings downward and forward into an internal roof portion of a passenger compartment of the vehicle.

40. The improved vehicle of claim 23 wherein extending the second cargo bed aft enlarges the overall cargo bed length by at least 40 percent.

41. The improved vehicle of claim 23 wherein extending the second cargo bed aft enlarges the overall cargo bed length by at least 65 percent.

42. The improved vehicle of claim 23 wherein extending the second cargo bed aft enlarges the overall cargo bed length by at least 90 percent.

43. The improved vehicle of claim 23 wherein said vehicle is a pickup truck.

44. The improved vehicle of claim 23 wherein said vehicle is a SUV.

45. In an improved pickup truck with a first cargo bed member, the improvement comprising:
a second cargo bed member wherein said second cargo bed member is extendable aft beyond the first cargo bed member to thereby create a longer cargo bed for the improved pickup truck and said second cargo bed member having a tailgate disposed proximal its aft end.

46. The improved vehicle of claim 45 wherein a lighting member is disposed, at least in part, on the second cargo bed member and is deployed rearward with the second cargo bed member when the second cargo bed member is extended to its aft position.

47. The improved vehicle of claim 45 wherein the second cargo bed member slides aft from under the first cargo bed member during rearward extension of the second cargo bed member.

48. In an improved SUV, the improvement comprising:
An extendable cargo bed member wherein said extendable cargo bed member is extendable aft beyond the passenger compartment of the SUV to thereby create a cargo bed for the improved SUV and said extendable cargo bed member having a tailgate disposed proximal its aft end.

49. The improved SUV of claim 48 wherein a lighting member is disposed, at least in part, on the extendable cargo bed member and is deployed rearward with the extendable cargo bed member when the extendable cargo bed member is extended to its aft position.

50. The improved SUV of claim 48 wherein a rear window of the SUV swings upward and forward over a portion of a passenger compartment of the SUV.

51. The improved SUV of claim 1 wherein a rear window of the SUV swings downward and forward into an internal roof portion of a passenger compartment of the SUV.

52. In an improved vehicle with a first cargo bed member, the improvement comprising:
a second cargo bed member wherein said second cargo bed member is extendable aft beyond the first cargo bed member to thereby create a longer cargo bed for the improved vehicle and wherein a lighting member is disposed, at least in part, on the second cargo bed member and is deployed rearward with the second cargo bed member when the second cargo bed member is extended to its aft position.

53. The improved vehicle of claim 52 wherein a cargo tailgate member is in mechanical communication with the second cargo bed member and moves forward and aft with the second cargo bed member.

54. The improved vehicle of claim 53 wherein a main bumper member is in mechanical communication with the second cargo bed member and moves forward and aft with the second cargo bed member.
